(19) United States
(12) Patent Application Publication
(10) Pub. No.: US 2023/0307987 A1
(43) Pub. Date: Sep. 28, 2023

(54) DEVICE, A SYSTEM AND A METHOD TO CONVERT REPETITIVE AND/OR RECIPROCATING MOTION INTO USEFUL FORMS OF ENERGY

(71) Applicants: Satpal Sharma, Fort Mcmurray (CA); Setu Sharma, Fort Mcmurray (CA)

(72) Inventors: Satpal Sharma, Fort Mcmurray (CA); Setu Sharma, Fort Mcmurray (CA)

(21) Appl. No.: 18/324,963

(22) Filed: May 27, 2023

(51) Int. Cl. H02K 7/06; H02K 5/00

(52) U.S. Cl. CPC H02K 7/06; H02K 5/00

(57) ABSTRACT

An aspect of the present invention provides a system, a device and a method to utilize useful movements and energy gained from the conversion of the repetitive/reciprocating motion for converting into circular motion. More specifically, the invention described in this application converts reciprocating motion to a useful form of energy such as electricity. The source of the reciprocating motion in this case is a shock absorber in a vehicle however, any components/system capable of working as a shock absorber can utilize this invention to converts reciprocating motion to a useful form of energy such as electricity. In an example, this invention can be implemented in conveyers, bridges, roadways with cars, pathways for pedestrians, trains, buildings, gym equipment etc. there is an endless list of scenarios where this method can be applied to make use of the available repetitive motion to be converted to electricity or other forms of energy.

### CROSS-REFERENCE TO RELATED APPLICATIONS

This application claims the benefit of the filing date of U.S. Provisional Application Ser. No. 63/347,000 titled “Method to convert repetitive motion into useful forms of energy” and filed 30 May 2022 and the subject matter of which is incorporated herein by reference

### TECHNICAL FIELD

The technology herein relates to field of energy regeneration, and more particularly, to a device, a system and a method to convert repetitive and/or reciprocating motion into useful forms of energy.

### BACKGROUND

The following description includes information that may be useful in understanding the present invention. It is not an admission that any of the information provided herein is prior art or relevant to the presently claimed invention, or that any publication specifically or implicitly referenced is prior art.

Energy regeneration is a technique that recovers and reuses wasted energy in conventional machinery. Energy conversion is the process of converting one form of energy into another form of energy.

Existing shock dampers operate on hydraulic principles. The dampening effect comes from the movement in viscous oil in the shock damper and also pushing of that oil through holes which creates residual heat which is wasted.

Existing regenerative shock absorbers operate on electromagnetic principles. These use linear reciprocating motions in a shock absorber to directly generate electricity using electromagnetic principles.

For example, regenerative suspension, also known as regenerative shock absorber, can harvest the vibration energy of the suspension simultaneously during driving. The hydraulic regenerative suspension uses the hydraulic transmission systems (HTS) to achieve vibration energy harvesting. The vibration energy is first converted into hydraulic energy and electrical energy and then stored in the accumulator and the battery, respectively. The energy flow of vibration energy harvesting is represented by flow of the hydraulic energy and electrical energy converted into the active force.

In spite of having many such examples of systems, devices and methods of energy regeneration, there still exists a dire need to provide a device, system and method that can regenerate energy from repetitive and/or reciprocating sources of motion. The energy from repetitive motion can be converted into energy such as but not limited to electricity. There still exists a huge scope to utilize other forms of useful movements and energy gained from the conversion of the repetitive/reciprocating motion energy regeneration.

In this specification if reference has been made to patent specifications, other external documents, or other sources of information, this is generally for the purpose of providing a context for discussing the features of the invention. Unless it is specifically stated otherwise, reference to such external documents is not to be construed as an admission that such documents, or such sources of information, in any jurisdiction, are prior art or form part of the common general knowledge in the art.

### SUMMARY OF THE INVENTION

In view of the above-mentioned shortcomings of energy regeneration techniques according to the prior art, the purpose of the present invention is to regenerate energy from repetitive and/or reciprocating motion/s where the original source of the motion does not necessarily have to be repetitive or reciprocating.

This objective is achieved by a device, a system and a method to convert repetitive and/or reciprocating motion into useful forms of energy according to the present invention. Aspects of the present invention provides a system, a device and a method to utilize useful movements and energy gained from the conversion of the repetitive/reciprocating motion or motions capable of producing a repetitive/reciprocating motion in the claimed invention for converting into circular motion. More specifically, the invention described in this application converts reciprocating motion to a useful form of energy such as electricity. The source of the reciprocating motion in this case is a shock absorber in a vehicle however; any components/system capable of being a source of motion for this invention can utilize this invention to convert reciprocating motion to a useful form of energy such as electricity. The invention helps to compensate the work done by the shock absorber and the energy dissipated by converting that energy into a useful form.

In an example, this invention can be implemented in conveyers, bridges, roadways with cars, pathways for pedestrians, trains, buildings, gym equipment etc. there is an endless list of scenarios where this method can be applied to make use of the available repetitive motion to be converted to electricity or other forms of energy.

According to a preferred aspect of the present invention, a method of regenerative dampening system as opposed to regenerative shock absorber is provided. The method focuses on the shock damper and not the shock absorber. It produces a smoother motion which in turn produces a smoother output of electricity as opposed to the abrupt up and down motions from which the existing regenerative shock absorbers produce electrical energy. The present invention makes use of the weight component of the vehicle in downward direction and builds up momentum using repeated physical force by converting it into a circular motion.

The present invention utilizes the vertical motion or up and down motion of an automobile suspension relative to frame of the vehicle to recover energy, when the vehicle is travelling on a road. The invention provides energy conversion means for converting the energy relating to vertical motion of the vehicle frame relative to the vehicle suspension to a form of energy which can be stored for later use. The power can be used to recharge batteries or other energy storage devices rather than being dissipated. The invention is designed for optimal regenerative electro mechanical system.

The present invention replaces or complements the shock dampening system and converts the reciprocating motion of a shock absorber into rotational motion, repeated impacts in the same direction in my method helps build up rotational inertia which can then be transferred to an energy storage device such as a flywheel or can be used to rotate the rotor of a generator directly to produce electricity.

The present invention is able to achieve a smoother output of electricity.

Another advantage is the possibility of being able to produce electricity in alternating current (AC) which can then be manipulated with variable frequency drives (VFDs) or converted into direct current (DC) for storage.

The summary of the invention does not necessarily disclose all the features essential for defining the invention. The invention may reside in a sub-combination of the disclosed features. The various combination and sub-combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 is a sectional side view of the device in order to show the basic concept of device function, in accordance with a preferred embodiment of the invention.

FIG. 2 is a sectional side view showing connection of the device to the generator, in accordance with a preferred embodiment of the invention.

FIG. 3 shows different ways to setup the design in order to explain the basic concept with or without an energy storage device such as flywheel, in accordance with a preferred embodiment of the invention.

FIG. 4 shows a side view of what the device setup with this method can look like, in accordance with a preferred embodiment of the invention.

FIG. 5 shown an alternate method for the implementation of the present invention, in accordance with a preferred embodiment of the invention.

FIG. 6 is a spring-loaded teeth, shows an Axle with a gear end that can be used for implementation of the present invention, in accordance with a preferred embodiment of the invention.

FIGS. 7-8 shows different methods in block diagram form explaining the invention for easy understanding, in accordance with a preferred embodiment of the invention.

FIG. 9 illustrates a method utilizing an animal as driver to harness energy, in accordance with a preferred embodiment of the invention.

FIG. 10 illustrates the top view of the setup described in FIG. 9, in accordance with a preferred embodiment of the invention.

FIG. 11 illustrates the gear mechanism of a bicycle used in generating energy, in accordance with the preferred embodiment of the invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

An aspect of the present invention provides a system, a device and a method to utilize useful movements and energy gained from the conversion of the repetitive/reciprocating motion for converting into circular motion. More specifically, the invention described in this application converts reciprocating motion to a useful form of energy such as electricity. The source of the reciprocating motion in this case is a shock absorber in a vehicle however; any components/system capable of producing the repetitive motion in the invention can utilize this invention to convert reciprocating motion to a useful form of energy such as electricity.

In an example, this invention can be implemented in conveyers, bridges, roadways with cars, pathways for pedestrians, trains, buildings, gym equipment etc. there is an endless list of scenarios where this method can be applied to make use of the available repetitive motion to be converted to electricity or other forms of energy.

According to a preferred aspect of the present invention, a method of regenerative dampening system as opposed to regenerative shock absorber is provided. The method focuses on the shock damper and not the shock absorber. It produces a smoother motion which in turn produces a smoother output of electricity as opposed to the abrupt up and down motions from which the existing regenerative shock absorbers produce electrical energy. The present invention makes use of the weight component of the vehicle in downward direction and builds up momentum using repeated physical force by converting it into a circular motion.

The present invention replaces or complements the shock dampening system and converts the reciprocating motion of a shock absorber into rotational motion, repeated impacts in the same direction in my method helps build up rotational inertia which can then be transferred to an energy storage device such as a flywheel or can be used to rotate the rotor of a generator directly to produce electricity.

The present invention is able to achieve a smoother output of electricity.

Another advantage is the possibility of being able to produce electricity in alternating current (AC) which can then be manipulated with variable frequency drives (VFDs) or converted into direct current (DC) for storage.

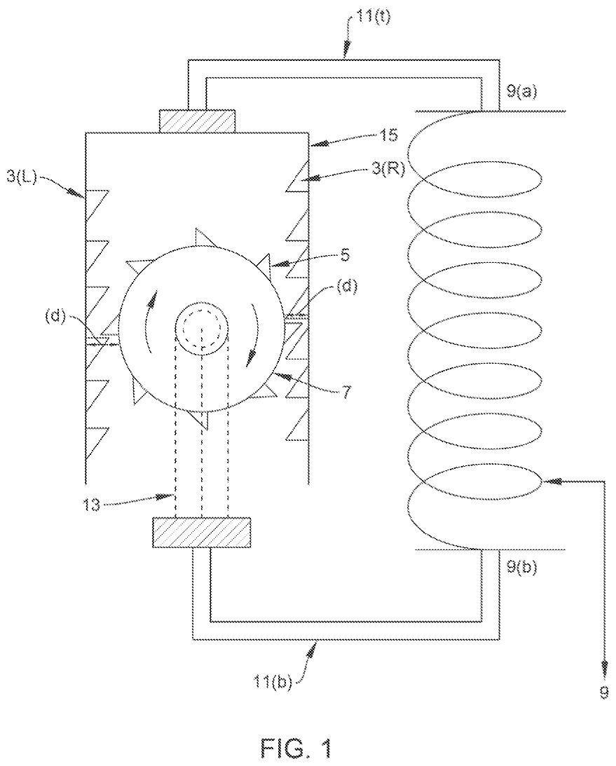

As shown in FIG. 1, a frame (15) is connected by a solid frame or a bar (lit) (metal or nonmetal) to the top part of the source of reciprocating motion (9a). The source of reciprocating motion in this case is a spring from a shock absorber but could be anything else. The goal is to ensure the frame (15) moves in the same direction and with the same force as (9a) by creating a rigid connection between the source of the motion and the damper device frame. The frame (15) has teeth as shown in the FIG. 1. The teeth (3R) and (3L) are spring loaded which allow them to collapse into the wall of frame (15) when a force is applied vertically from the side and spring back up when that force is removed. The teeth (3R) stay rigid and do not collapse when force is applied from top and the frame 15 is moving downwards. Teeth (3L) do not collapse and stay rigid when force is applied from below and the frame 15 is moving upwards.

(7) is a free to move in any direction wheel similar to a gear with modified teeth mounted on it as shown in FIG. 1. The teeth (5) on (7) can be spring loaded or rigid and it is optional. (7) is mounted on the bearings which are supported on a solid frame (13) (metal or nonmetal). Axle connects the frame (13) to (7) and allows free movement with minimum friction.

As (7) rotates in clockwise direction, the teeth (5) will apply a force on teeth (3R) and (3L) and collapse them into the frame (15) which will allow free movement of (7) in a clockwise direction without being impeded by (3R) and (3L).

When frame (15) is moving downwards relative to (13), teeth (3R) will apply a force in a clockwise direction on (7) due to the teeth grabbing each other but the teeth (3L) will collapse. When frame (15) is moving upwards relative to (13), the teeth (3R) will collapse and (3L) will apply a clockwise force on (7) further rotating it in clockwise motion.

The number, size and shape of (3L), (3R), (5) can be modified as per requirements. The FIG. 1 representation is only for easy understanding of the concept behind the method. The higher the number of teeth that can be packed on the frames, the more efficient system becomes by capturing smaller and smaller movements between frame (15) and (13). The distance (d) can also be increased or decreased based on the design requirements and other considerations such as the size, number and shape or the teeth.

(13) is connected to (9b) via (11b) in order to ensure a rigid connection between the bottom part of the source of reciprocating motion and (13). (11b) can be metal or non-metal or any other material that meets the design requirements and the forces it will be subjected to.

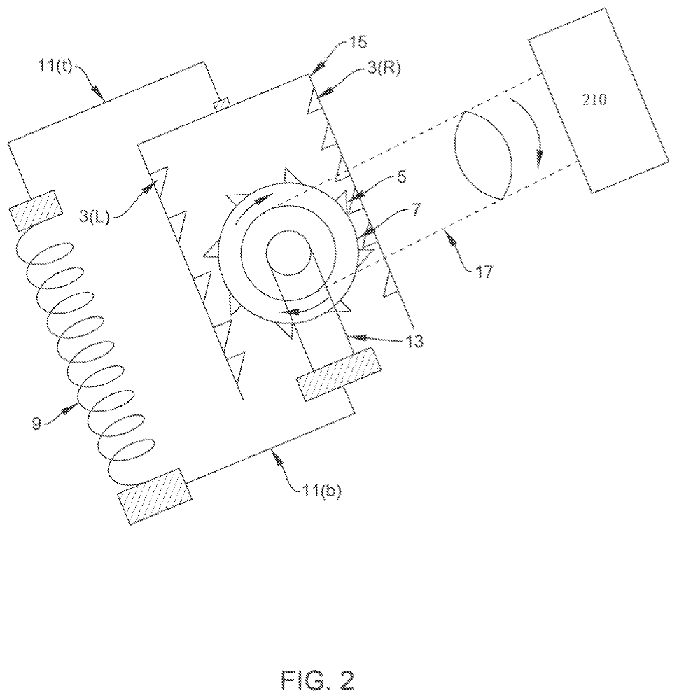

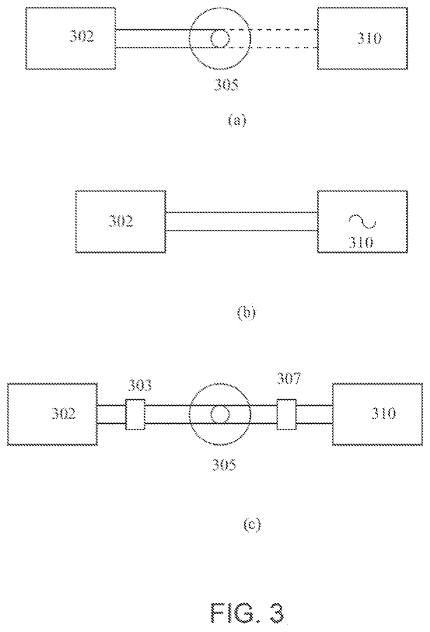

FIG. 2 is a sectional side view showing connection of the device to the generator and FIG. 3 shows different ways to setup the design in order to explain the basic concept with or without an energy storage device such as flywheel.

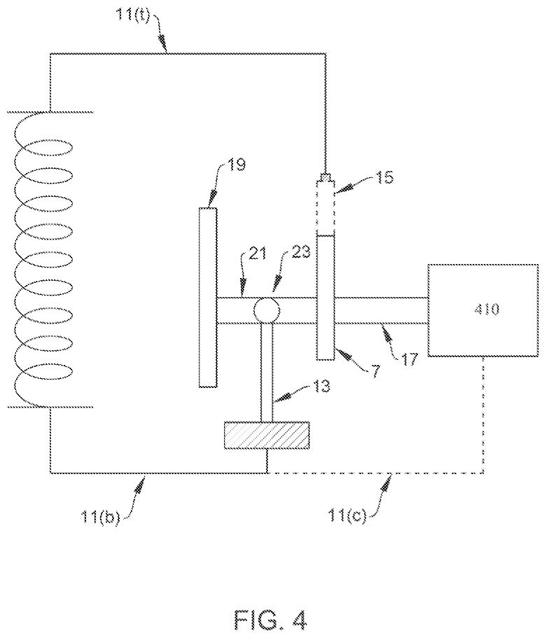

FIG. 4 shows a side view of what the device setup. A flywheel (19) can also be mounted on (21) in order to store the rotational inertia and build up on it with the subsequent impacts from the reciprocating motion. The flywheel can be replaced with any other energy storing device as well and the purpose is to store and smoothen the flow of energy to the output at which is a generator. Axle (17) connects the clockwise moving frame to the generator rotor or any other device where the motion can be harnessed for other uses. (11c) ensures the rigid connection between (7) and generator so they stay in the same plane.

The current setup was used for easy explanation of the concept. The placement or flywheel, generator and other components is flexible as per the design requirements, space constraints and location where the method is to be used. The wheel (7) can also move in counterclockwise (CCW) direction by making some obvious changes.

To elaborate on the best mode of working, it can be appreciated that, the road a vehicle drives on applies various forces on the tires which gets absorbed by the shock absorbers of the vehicle. This is because the road is not a perfect flat surface. The process of shock absorption causes a displacement of the shock springs causing it to move up and down in a reciprocating motion as the energy transferred from the bumps and road imperfections is absorbed and dissipated by the shock absorber and damper for a smoother ride. This invention provides a method to connect a device which will be connected with the shock absorber and use that reciprocating motion to rotate a gear/wheel in one direction. The rotation produced can be used to drive shafts which can drive a generator rotor. With every impact resulting from repetitive displacement of shock absorber, that force is used to build more and more momentum in wheel 7 and subsequently in the energy storage device 19 or the rotor itself.

Referring to FIG. 1, When Frame 15 is moving downwards relative to 13, teeth 3R will apply a force in a clockwise direction on 7 due to the teeth grabbing each other but the teeth 3L will collapse allowing hindrance free motion of 7 in clockwise direction. When Frame 15 is moving upwards relative to 13, the teeth 3R will collapse and 3L will apply a clockwise force on 7 further rotating it in clockwise motion. This way energy is harnessed in both downwards and upwards motion.

As 7 rotates in clockwise direction, the teeth 5 will apply a force on teeth 3R and 3L and collapse them into the frame 15 which will allow free movement of 7 in a clockwise direction without being impeded by 3R and 3L.

As the reciprocating motion between 15 and 13 repeats—it will lead to 7 building up momentum and continuing to rotate in a clockwise direction. The clockwise rotation will rotate shaft 17 which can then be used to rotate an energy storage device such as a flywheel. If an energy storage device is being employed, an engage/disengage mechanism can also be used (optional) to disconnect and connect the generator rotor from the rotating shaft 17.

Alternatively, Shaft 17 can also be used to rotate the rotor of a generator directly without the use of an energy storage device.

As the generator rotor rotates, the movement can be used to produce electricity which can either be used directly or converted to an appropriate frequency via a VFD or can be converted to DC power in order to be used for a purpose or to charge a battery.

The field of the generator can be manipulated to increase/decrease the dampening effect from this method on the shock absorber. Higher damping factor would lead to a higher electrical output.

The angle, shape, size, smoothness and number of teeth 3R, 3L, 5 can be modified to meet the design requirements, space constraints or to manipulate the efficiency of the method. The smallest displacement of shock absorber that can be harnessed to rotate wheel 7 will be directly related to the number of teeth that can be tightly packed on frame 15 and 7.

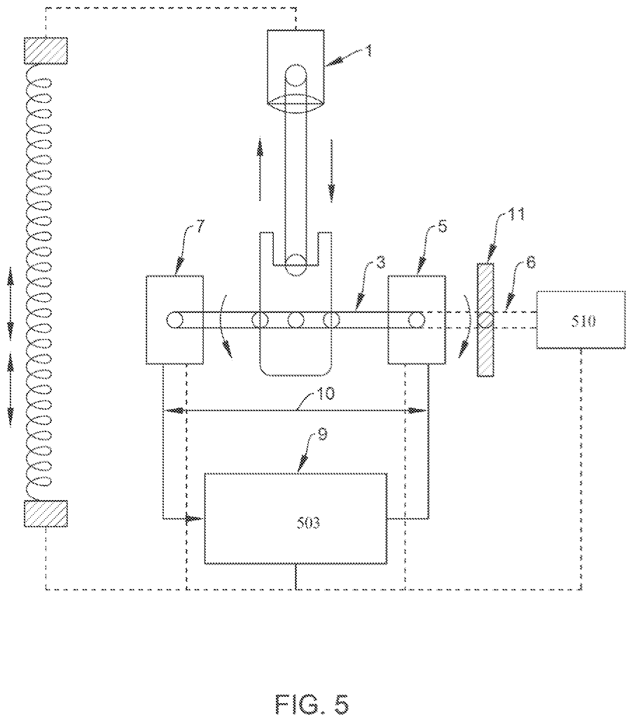

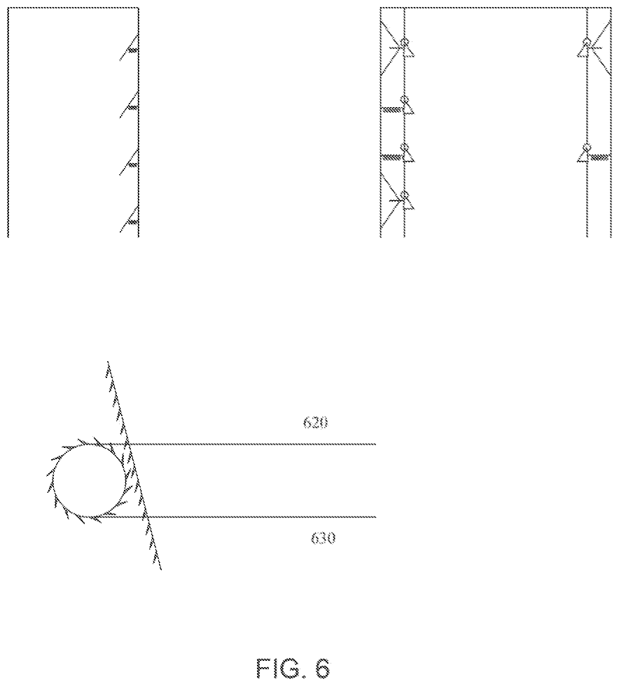

FIG. 5 describes an alternative method of a regenerative damping system. In this method, a crankshaft is used to move a shaft 3 both clockwise and anticlockwise directions. Both these directional movements are harnessed in order to move the shaft connected to either an energy storage device and generator rotor or directly to a generator rotor only.

As 1 moves downwards relative to 5 &7, the shaft 3 can be made to move either move in a clockwise or an anticlockwise direction based on the setup. Similarly, when 1 moves upwards relative to 5 &7, the shaft 3 can be made to rotate in a C.W. or a C.C.W. direction.

For the purpose of this explanation, as 1 moves down the shaft 3 turns in a C.W. direction. 5 is a one-way mechanism which allows transfer of rotational power only in clockwise direction and freewheels in the C.C.W. direction. Shaft 3 generates motion in 5 in C.W. direction as 1 moves downwards which in turn rotates 6 in a C.W. motion. 5 freewheels in the opposite direction as 1 moves upwards. 6 is connected to an energy storage device such as a flywheel 11 and generator rotor or directly to a generator rotor.

7 is a one way mechanism that allows transfer of rotational power only in the C.C.W. direction while freewheeling in the opposite direction. Hence, 7 generates power as 1 moves upwards and freewheels when 1 moves downwards.

6 and 7 can be a mechanism similar to the one described in FIG. 1 or any other one-way rotation mechanism as well which freewheels in opposite direction. When 7 starts to rotate in the C.C.W. direction, the gear arrangement connected to 7 converts the C.C.W. motion into C.W. motion feeding that power directly on to 6 in 5 or outside of it via a gear and shaft linkage as shown in FIG. 5.

When the vehicle moves through a bumpy road, the shock absorber moves up and down. When the gears are rotated converting the linear motion into rotational motion. A one-way Ratchet mechanism is used to capture continuous clockwise motion. The ratchet allows continuous rotary motion in only one direction and preventing motion in the opposite direction. The motion energy can be transferred to an energy storage device such as a flywheel or can be used to rotate the rotor of a generator directly to produce electricity.

As 1 moves up and down repeatedly, the power is transferred to 6 as described above. As power builds up on 6 with each stroke, that rotation is fed into a generator rotor in order to produce electricity. This also provides a damping effect on the shock absorber 1 is connected to as shown in FIG. 5. The output of the generator can be manipulated in order to manipulate the damping provided by this mechanism.

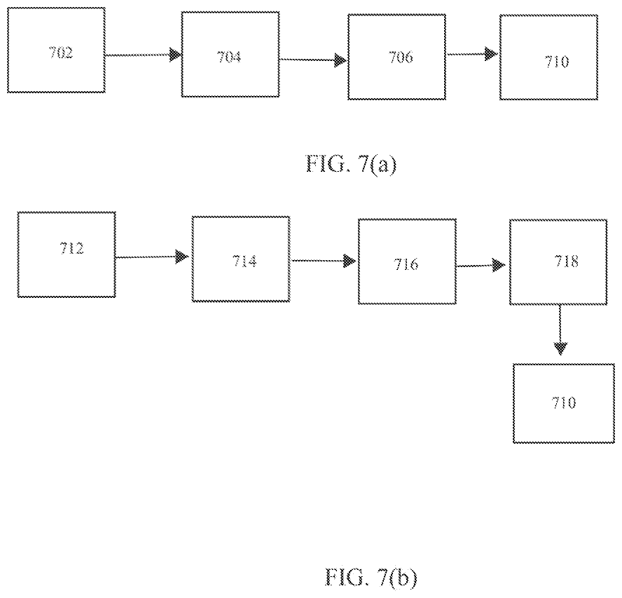

FIG. 7 describes another alternative third method of setting up a regenerative damping system where multiple one way devices similar or different from the device explained in FIG. 7, can be connected to a common generating device or an energy storing device such as a flywheel. These devices then provide a one direction motion for the common generating/storage device with each respective stroke on them.

FIG. 7 further illustrates in 7(a), there is a reciprocating power source 702, connected to the one way ratchet system 704 as shown in FIG. 1, the one way ratchet system is further connected to flywheel based rotational energy storage system 706, which inturn connected to the power generator 710.

In FIG. 7b, a crankshaft mechanism 712 is connected to 2 one way ratchet mechanism system 714, the ratchet mechanism system is further connected to a gearbox or a gear arrangement to convert to one direction motion 716. An optional rotational energy storage device 718 is connected to the power generator 710.

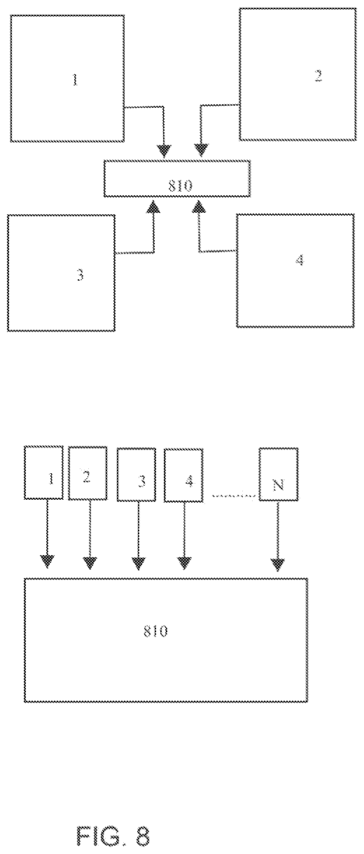

FIG. 8 illustrates an example can be having the damping devices on each wheel of a vehicle feeding into a common generating or storage device 810 instead of having 4 separate generators producing power separately or 4 separate energy storage devices. The linkage between the one way devices 1-4 and a common generating/storage device 810 can be made with shafts and gears. Another example can be a conveyor shock absorber system or a roadway/pathway with regenerative damping system setup underneath, where multiple damping devices 1 to N, can be installed in order to feed into a common energy storage or generating device.

In an exemplary implementation, following may be considered as possible alternatives, possibilities and modifications to achieve the preferred effects:

The size, shape, smoothness, angles of 3R, 3L and 5 can be modified to meet the design and efficiency requirements.

Source of motion does not necessarily need to be a shock absorber on a vehicle, this method can be used on gym equipment, pedestrian pathways with people walking on it, roadways with vehicles driving over it, conveyors, high rise buildings, bridges and any other source which has a reciprocating motion associated with it. This method allows harnessing power from different sources of reciprocating motion.

Gear ratios and simple or complex gear arrangements such as gearboxes can be used to increase/decrease the rotational velocity/rpm of the final output that is fed into a generating or an energy storage device or any other utility the motion obtained from this method is to be used for.

An engage/disengage mechanism can be added between 17 and the final output.

A simple gear with appropriate # of teeth as per specific design requirements can replace 7 in FIG. 1.

A wheel or free moving bearings or any other friction reducing device can also be added to the back of 3R, 3L and 5 in order to reduce the friction during the freewheeling portion of the cycle in order to reduce friction between the teeth as they collapse and move past one another.

Multiple frames can be combined together parallel to frame 15 making the frame 15 thicker. Also, multiple teeth (3R, 3L) can be mounted parallel to each other on the thicker wall of frame 15. The teeth parallel to each other can be displaced from each other by a certain distance. Similarly multiple frames can be combined together parallel to 7 to form a thicker wheel and more teeth (5) can be mounted on 7 that are parallel to each other. These teeth can be displaced by a certain distance from the teeth parallel to them. This is to make it easier to get the benefit of having a higher number of teeth for the whole setup.

In an embodiment, a device for utilizing repetitive or reciprocating (RR) motion of a source to store a RR energy is disclosed. The device includes a rectangular frame having a first connecting end and a second connecting end such that the first connecting end is connected to a first end of the source that generates the RR motion and the second connecting end is connected to a second end of the source.

The rectangular frame includes a plurality of spring-loaded structures provided on inner wall surfaces of the rectangular frame, and a plurality of spring-loaded structures provided on inner wall surfaces of the rectangular frame.

The rotatable flywheel is positioned inside the rectangular frame and connected to the rectangular frame through a rotatable axle such that the rotatable flywheel rotates when the source generates the RR motion and consequently at least one of the plurality of teeth structures are contactable to at least one of the plurality of spring-loaded structures provided on the inner wall surfaces while the rotatable flywheel is rotating.

Each of the plurality of spring-loaded structures are adapted to be compressed into at least one wall of the rectangular frame when a force is applied by the at least one at least one of the plurality of teeth structures and is adapted to be decompressed when the applied force is released.

A first energy generated by the rotation of the rotatable flywheel and a second energy generated by the compression and decompression of the plurality of spring-loaded structures are stored as the RR energy in an energy storing device.

In an exemplary implementation of this embodiment, the source is the RR motion is a spring from a shock absorber of a vehicle.

In an exemplary implementation of this embodiment, the first connecting end and the second connecting end moves in inverse direction of a movement of the first end of the source and the second end of the source respectively.

In an exemplary implementation of this embodiment, the inner wall surfaces of the rectangular frame are deformable.

In an exemplary implementation of this embodiment, the inner wall surfaces of the rectangular frame are non-deformable.

In an exemplary implementation of this embodiment, the teeth on the inner wall are retractable.

In an exemplary implementation of this embodiment, the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and teeth on the inner wall are retractable and are positioned on opposite sides of the rectangular frame facing each other.

In an exemplary implementation of this embodiment, the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and are positioned on opposite sides of the rectangular frame facing each other. In this implementation, the rotatable axle of the rotatable flywheel is coupled to the first inner wall surface and the second inner wall surface such that the rotatable flywheel rotates when at least one of the first inner wall surface and the second inner wall deforms and teeth on the inner wall retract.

In an exemplary implementation of this embodiment, the plurality of spring-loaded structures includes a first set of structures adapted to be compressed into the at least one wall of the frame when the force is applied vertically by the first connecting end and are adapted to be decompressed when the applied force is released, and a second set of structures adapted to be compressed into the at least one wall of the frame when the force is applied vertically by the second connecting end and are adapted to be decompressed when the applied force is released.

In an exemplary implementation of this embodiment, the outer surface of the rotatable flywheel is separated from each of the inner wall surfaces by a pre-determined distance.

In an exemplary implementation of this embodiment, the RR energy is utilized to rotate a rotor of a generator to generate an electrical energy from the RR energy.

In another embodiment, a system for utilizing repetitive or reciprocating (RR) motion of a source to store a RR energy is disclosed. The system includes a device having a rectangular frame having a first connecting end and a second connecting end such that the first connecting end is connected to a first end of the source that generates the RR motion and the second connecting end is connected to a second end of the source.

The rectangular frame includes a plurality of spring-loaded structures provided on inner wall surfaces of the rectangular frame, and a plurality of spring-loaded structures provided on inner wall surfaces of the rectangular frame.

The rotatable flywheel is positioned inside the rectangular frame and connected to the rectangular frame through a rotatable axle such that the rotatable flywheel rotates when the source generates the RR motion and consequently at least one of the plurality of teeth structures are contactable to at least one of the plurality of spring-loaded structures provided on the inner wall surfaces while the rotatable flywheel is rotating.

Each of the plurality of spring-loaded structures are adapted to be compressed into at least one wall of the rectangular frame when a force is applied by the at least one at least one of the plurality of teeth structures and is adapted to be decompressed when the applied force is released.

A first energy generated by the rotation of the rotatable flywheel and a second energy generated by the compression and decompression of the plurality of spring-loaded structures are stored as the RR energy in an energy storing device.

The system further includes a generator connected to the device such that a first energy generated by the rotation of the rotatable flywheel and a second energy generated by the compression and decompression of the plurality of spring-loaded structures are received by a rotor of the generator to generate an electrical energy.

In an exemplary implementation of this another embodiment, the source is the RR motion is a spring from a shock absorber of a vehicle.

In an exemplary implementation of this another embodiment, the first connecting end and the second connecting end moves in inverse direction of a movement of the first end of the source and the second end of the source respectively.

In an exemplary implementation of this another embodiment, the inner wall surfaces of the rectangular frame are deformable.

In an exemplary implementation of this another embodiment, the inner wall surfaces of the rectangular frame are non-deformable.

In an exemplary implementation of this another embodiment, the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and are positioned on opposite sides of the rectangular frame facing each other.

In an exemplary implementation of this another embodiment, the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and are positioned on opposite sides of the rectangular frame facing each other. In this implementation, the rotatable axle of the rotatable flywheel is coupled to the first inner wall surface and the second inner wall surface such that the rotatable flywheel rotates when at least one of the first inner wall surface and the second inner wall deforms.

In an exemplary implementation of this another embodiment, the plurality of spring-loaded structures includes a first set of structures adapted to be compressed into the at least one wall of the frame when the force is applied vertically by the first connecting end and are adapted to be decompressed when the applied force is released, and a second set of structures adapted to be compressed into the at least one wall of the frame when the force is applied vertically by the second connecting end and are adapted to be decompressed when the applied force is released.

In an exemplary implementation of this another embodiment, the outer surface of the rotatable flywheel is separated from each of the inner wall surfaces by a pre-determined distance.

In an exemplary implementation of this another embodiment, the RR energy is utilized to rotate a rotor of a generator to generate an electrical energy from the RR energy.

In yet another embodiment, a device connectable between two ends of a shock absorber such that the device is provided. The device utilizes reciprocating motion of the shock absorber to rotate a gear enclosed inside the device in at least one direction wherein the gear drives one or more drive shafts to drive a generator rotor of a generator to generate electricity.

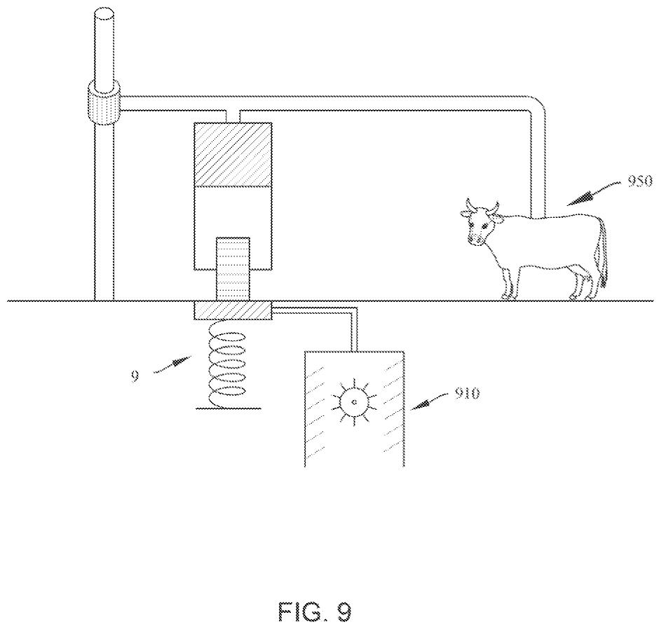

In yet another embodiment, the device allows using a unique method to use a driver (which can be configured to be an animal or any other driver) to generate the reciprocating motion in the device. The animal (950) goes in a circle around the center of rotation as illustrating in FIG. 9. The animal helps drive a certain amount of weight which is connected to the frame above a wheel assembly. The spring (9) attached to the generator (910) and the weight assembly to generate energy.

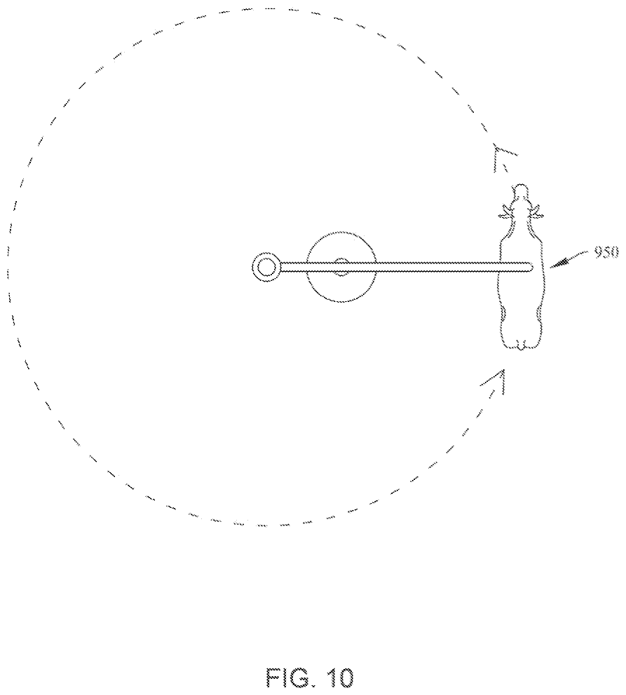

FIG. 10 illustrates the top view of the method illustrated in FIG. 9, in accordance with a preferred embodiment of the invention. Animal (950) seems to be rotated in circle illustrated by dotted line circle. The animal drives a certain amount of weight which is connected to the frame above a wheel assembly. The spring (9) is further connected to the generator (910) and the weight assembly to generate energy.

The wheel presses the string connected to the device, transferring the force of the weight to the spring compressing it. As the wheel moves away, the spring decompresses creating the reciprocating motion in the device. A series of devices can be placed in the path of the wheel to harness more energy.

In another embodiment, a gear assembly of the bicycle or similar device can be a standalone device to convert repetitive motion into useful energy. The source of motion was connected to the middle gear assembly (1103), which were connected to gears (1101) and (1102), with a chain or belt or any other similar connecting means.

As the source of the motion moves downward, it rotates the gear (1101) in clockwise direction and gear (1102) in counter clockwise direction and vice versa.

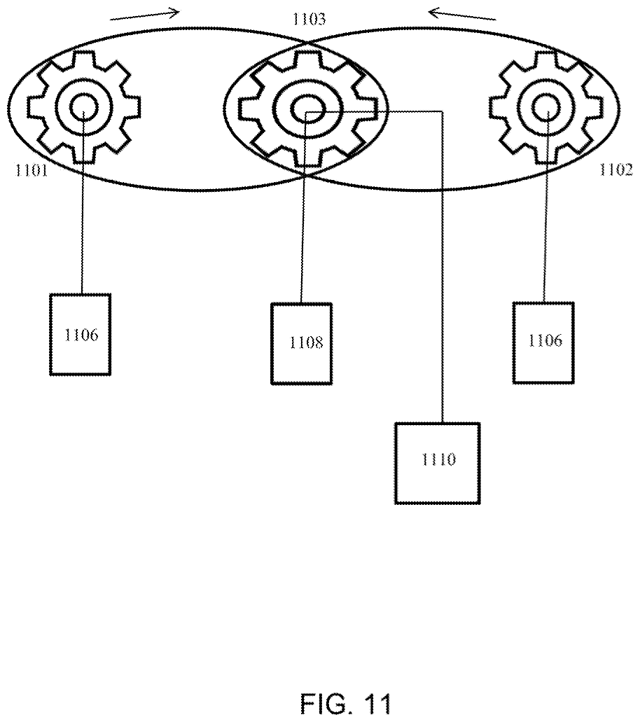

A source of motion is connected is to middle gear (1103), whereas the generator is connected to the gears (1102) and (1103) as illustrated in FIG. 11.

Generator 1106 is connected to the gear and 1110 is the source of energy and 1108 is the mass connected to the gear 1103.

Various setup of the same or similar device can be achieved by putting one or more gears in parallel.

The system can be implemented in other forms of gear mechanisms, not limited to the one disclosed in the application. Other implementation will also be covered in the scope of the patent application.

The wheel presses the spring connected to the device, transferring the force of the weight to the spring compressing it. As the wheel moves away, the spring decompresses creating the reciprocating motion in the device. A series of devices can be placed in the path of the wheel to harness more energy.

While the subject invention is described and illustrated with respect to certain preferred and alternative embodiments, it should be understood that various modifications can be made to those embodiments without departing from the subject invention, the scope of which is defined in the following claims.

What is claimed is:

1. A device for producing and utilizing repetitive or reciprocating (RR) motion from a source, to convert not transfer a RR energy to rotational energy which can be converted into other forms of energy such as but not limited to electrical, the device comprising:
a frame having a first connecting end and a second connecting end such that the first connecting end is connected to a first end of the source that generates the RR motion and the second connecting end is connected to a second end of the source;
wherein the frame comprising:
a plurality of spring-loaded structures provided on inner wall surfaces of the frame; and a rotatable flywheel enclosed inside the frame and having a plurality of teeth structures provided on its outer surface, the rotatable frame is positioned inside the outside frame and connected to stable frame through a rotatable axle such that the rotatable frame rotates when the source generates the RR motion and consequently at least one of the plurality of teeth structures are contactable to at least one of the plurality of spring-loaded structures provided on the inner wall surfaces while the rotatable frame is rotating;
wherein each of the plurality of spring-loaded structures are adapted to be compressed into at least one wall of the outside frame when a force is applied by the at least one at least one of the plurality of teeth structures and is adapted to be decompressed when the applied force is released; and
wherein a first energy generated by the rotation of the rotatable flywheel and a second energy generated by the compression and decompression of the plurality of spring-loaded structures, which is stored or harnessed directly to produce or utilize the said RR energy in an energy storing device or for producing other forms of energy.

2. The device of claim 1, wherein the source of the RR motion is any source including but not limited to spring from a shock absorber of a vehicle.

3. The device of claim 1, wherein the source of RR motion is pedestrian traffic, gym equipment, animal driven system or any other source capable of compressing device springs.

4. The device of claim 1, wherein the device captures energy in both directions of motion of the device to produce rotation in one direction, similar to a ratchet mechanism.

5. The device of claim 1 wherein an energy storing device such as but not limited to a flywheel can be employed to store the energy generated from the device.

6. The device of claim 1, wherein the first connecting end and the second connecting end moves in inverse direction of a movement of the first end of the source and the second end of the source respectively.

7. The device of claim 1, wherein the inner wall surfaces of the rotating or outside frame are either retractable or non-retractable and teeth on the opposite wall retract, which are positioned on opposite sides of the outside frame facing each other.

8. The device of claim 1, wherein the rotatable axle of the rotatable flywheel is coupled to the first inner wall surface and the second inner wall surface such that the rotatable frame rotates when at least one of the first inner wall surface and the second inner wall deforms and teeth on the inner wall retract to allow rotation in one direction.

9. The device of claim 1, wherein the plurality of spring-loaded structures comprising:
a first set of structures adapted to be compressed into the at least one wall of the frame when the force is applied vertically by the first connecting end and are adapted to be decompressed when the applied force is released; and
a second set of structures adapted to be compressed into the at least one wall of the frame when the force is applied vertically by the second connecting end and are adapted to be decompressed when the applied force is released.

10. The device of claim 1, wherein the RR energy is utilized to rotate a rotor of a generator to generate an electrical energy or other form of energy from the RR energy.

11. A system for utilizing motion in a source by converting it to repetitive/reciprocating motion which can be used to store or transfer the energy, the system comprising:
a device having a frame having a first connecting end and a second connecting end such that the first connecting end is connected to a first end of the source that generates the motion and the second connecting end is connected to a second end of the source;
wherein the outside frame comprising:
a plurality of spring-loaded structures provided on inner wall surfaces of the rectangular frame; and a rotatable frame enclosed inside the outside frame and having a plurality of teeth structures provided on its outer surface, the rotatable frame is positioned inside the outside frame and connected to a stable frame through an axle such that the rotatable flywheel rotates when the source generates the RR motion and consequently at least one of the plurality of teeth structures are contactable to at least one of the plurality of spring-loaded structures provided on the inner wall surfaces while the rotatable flywheel is rotating;
wherein each of the plurality of spring-loaded structures are adapted to be compressed into at least one wall of the rectangular frame when a force is applied by the at least one at least one of the plurality of teeth structures and is adapted to be decompressed when the applied force is released; and
a generator connected to the device such that a first energy generated by the rotation of the rotatable flywheel and a second energy generated by the compression and decompression of the plurality of spring-loaded structures are received by a rotor of the generator to generate an electrical energy.

12. The system of claim 11, wherein the source is the RR motion is a spring from a shock absorber of a vehicle.

13. The system of claim 11, wherein the first connecting end and the second connecting end moves in inverse direction of a movement of the first end of the source and the second end of the source respectively.

14. The system of claim 11, wherein the inner wall surfaces of the rectangular frame are deformable or non-deformable and teeth on the inner wall are retractable.

15. The system of claim 11, wherein the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and teeth on the inner wall are retractable and are positioned on opposite sides of the rectangular frame facing each other.

16. The system of claim 11, wherein the first connecting end is provided on a first inner wall surface selected from the inner wall surfaces of the rectangular frame and the second connecting end is provided on a second inner wall surface selected from the inner wall surfaces of the rectangular frame, such that, the first inner wall surface and the second inner wall surface is deformable and are positioned on opposite sides of the rectangular frame facing each other, and
wherein the rotatable axle of the rotatable flywheel is coupled to the first inner wall surface and the second inner wall surface such that the rotatable flywheel rotates when at least one of the first inner wall surface and the second inner wall deforms.

17. The system of claim 11, wherein the plurality of spring-loaded structures comprising:
a first set of structures adapted to be compressed into the at least one wall of the frame when the force is applied vertically by the first connecting end and are adapted to be decompressed when the applied force is released; and
a second set of structures adapted to be compressed into the at least one wall of the frame when the force is applied vertically by the second connecting end and are adapted to be decompressed when the applied force is released.

18. The system of claim 11, wherein the device captures energy in both directions of motion of the device to produce rotation in one direction similar to a ratchet mechanism.

19. The system of claim 11, wherein the RR energy is utilized to rotate a rotor of a generator to generate an electrical energy or other form of energy from the RR energy.

20. A method for generating or transferring electrical energy, the method utilizes a device or a system connectable between two ends of a shock absorber such that the device utilizes reciprocating motion of the shock absorber to rotate a gear enclosed inside the device in at least one direction wherein the gear drives one or more drive shafts to drive a generator rotor of a generator to generate an electrical energy or other forms of energy.
